(19) United States
(12) Patent Application Publication
(10) Pub. No.: US 2026/0228667 A1
(43) Pub. Date: Aug. 6, 2026

(54) DEVICE AND METHOD FOR PREDICTING TALENT DEMAND BASED ON CORPORATE ROADMAP

(71) Applicant: ableJ Inc., Gyeonggi-do (KR)

(72) Inventors: Kyung Ho PARK, Gyeonggi-do (KR); Jong Won LEE, Seoul (KR); Mun Keun CHO, Gyeonggi-do (KR)

(21) Appl. No.: 19/411,576

(22) Filed: Dec. 8, 2025

(30) Foreign Application Priority Data
Feb. 5, 2025 (KR) 10-2025-0014487

(51) Int. Cl. G06Q 10/0637; G06Q 10/0631; G06Q 10/1053

(52) U.S. Cl. CPC G06Q 10/0637; G06Q 10/063118; G06Q 10/06315; G06Q 10/1053

(57) ABSTRACT

An apparatus and method for predicting required talent based on a corporate roadmap according to an embodiment integrate and structure various internal data such as a corporate's business plan, technology roadmap, and organizational expansion plan to predict key job roles and technical domains needed in the future. In addition, the apparatus and method for predicting required talent based on a corporate roadmap according to an embodiment enable objective and data-centric required talent prediction based on an AI algorithm without relying on existing empirical judgment. For example, it allows an automobile company aiming to develop autonomous vehicles to pre-hire and train autonomous driving software developers and AI engineers in line with specific milestones.

### CROSS-REFERENCE TO RELATED APPLICATION

This application claims priority to and the benefit of Korean Patent Application No. 10-2025-0014487, filed on Feb. 5, 2025, the disclosure of which is incorporated herein by reference in its entirety.

### BACKGROUND

### 1. Field of the Invention

The present disclosure relates to an apparatus and method for predicting required talent based on a corporate roadmap, and more specifically, to a prediction apparatus and method that structures various data provided by a corporate and identifies key job roles and technical domains that the corporate will need in the future through artificial intelligence.

### 2. Discussion of Related Art

Unless otherwise indicated herein, the contents described in this section are not prior art to the claims in this application, and inclusion in this section is not an admission that they are prior art.

Technology for identifying job roles and technical domains needed in the future is an essential process for sustainable growth of a corporate. However, technology for predicting the future inherently involves uncertainty. In particular, because the pace of technological advancement is very rapid, predictions based on current data may be incorrect. For example, the commercialization timeline of autonomous vehicles was predicted, but it was delayed more than expected due to legal regulations and social acceptability issues.

In addition, the performance of data analysis and prediction technology for future prediction greatly depends on the quality of the input data. If inaccurate or incomplete data is used, incorrect results may be derived. In addition, prediction accuracy may decrease due to incomplete or biased data, and predictions based on past data may no longer be valid if rapid technological changes occur. In addition, skill requirements by job position or data from recruitment platforms may be biased toward specific regions or specific industries.

In addition, when an AI algorithm learns past employment patterns, it may reinforce existing biases for future predictions. In addition, since prediction technology is based on existing technology trends, it is difficult to capture the emergence of new skills such as “Disruptive Innovation.” Specifically, the emergence of new skills such as AI, blockchain, and quantum computing may often be missed in prediction models. In addition, existing prediction technology works well for incremental technological advancements but has poor predictive capability for innovative changes.

In addition, conventional technology for identifying technical domain makes it difficult to reduce the gap (Skill Gap) between the technology required for predicted future job roles and the technology of current personnel. This may cause disruptions in talent acquisition and operation of education programs. While the demand for talent capable of handling new skills increases rapidly, the speed of talent education and redeployment is slow, so even if prediction technology informs the necessity of future job roles, time is needed to nurture and secure suitable talent.

Examples of the related art include Korean Patent Publication No. 10-2021-0046599, and Korean Patent Registration No. 10-2640715.

### SUMMARY OF THE INVENTION

An apparatus and method for predicting required talent based on a corporate roadmap according to an embodiment systematically structures various data provided by a corporate. In the embodiment, the corporate-provided data includes, for example, a business plan, a technology roadmap, an organizational expansion plan, and the like, but is not limited thereto. In the embodiment, the corporate-provided data is analyzed through artificial intelligence, and key job roles and technical domains that the corporate will need in the future are identified according to the analysis result.

In addition, the apparatus and method for predicting required talent based on a corporate roadmap according to an embodiment performs demand analysis by corporate growth stage. In the embodiment, after identifying which stage the corporate is in, such as initial, growth, maturity, etc., talent suitable for the stage can be predicted.

In addition, the apparatus and method for predicting required talent based on a corporate roadmap according to an embodiment specifies required talent based on important milestones in the corporate roadmap.

In addition, the apparatus and method for predicting required talent based on a corporate roadmap according to an embodiment continuously updates a recommended talent list according to changes in corporate strategy including goal adjustments and technology changes, and changes in the candidates' career histories.

In addition, the apparatus and method for predicting required talent based on a corporate roadmap according to an embodiment performs long-term talent pool management. In the embodiment, talent needed at a specific point in time can be secured in advance according to the corporate roadmap and industry trends.

In addition, the apparatus and method for predicting required talent based on a corporate roadmap according to an embodiment performs customized matching of a talent's capability-development skill-tree with the corporate roadmap and visualizes a personalized growth path. In the embodiment, skills, certifications, experiences, etc., required for a candidate to reach a specific career stage (e.g., project leader, department head) can be visualized in a skill-tree format.

In addition, the apparatus and method for predicting required talent based on a corporate roadmap according to an embodiment performs matching with the corporate roadmap, thereby connecting specific capabilities required in the corporate's mid-to long-term strategy with growth potential on an individual skill-tree.

In addition, through the embodiment, a corporate secures talent needed in the medium to long term, and a candidate obtains customized opportunities that can support their own career growth. Through the embodiment, if a candidate acquires necessary skills through educational opportunities provided by the corporate, a virtuous cycle structure in which both the corporate and the candidate grow is created. This invention provides long-term value to both the corporate and the candidate, and presents a new headhunting paradigm that goes beyond the existing short-term vacancy filling method.

However, the problems to be solved according to an embodiment are not limited to those mentioned above.

An apparatus for predicting required talent based on a corporate roadmap according to an embodiment includes: a memory storing at least one instruction for predicting required talent based on a corporate roadmap; and a processor performing operations according to the instructions, wherein the processor structures corporate-provided data, analyzes the corporate roadmap through an artificial intelligence model based on the structured corporate-provided data, and identifies future key job roles and technical domains required according to the corporate roadmap according to the analysis result.

In addition, the processor determines the corporate's growth stage through the analysis of the corporate roadmap, and predicts required talent corresponding to the corporate-specific future key job roles and technical domains based on the determined corporate growth stage.

In addition, the processor specifies required talent by growth stage based on at least one milestone that serves as a target for each corporate growth stage of the corporate roadmap.

In addition, the processor generates a capability-development skill-tree according to individual information of each candidate, and generates a company-specific recommended talent list from among candidates whose generated capability-development skill-tree are matched with the corporate roadmap.

In addition, the processor extracts required skills, certifications, and experience information from individual information of each candidate to achieve the capability-development skill-tree matched with the corporate roadmap.

In addition, the processor extracts specific capabilities required in a mid- to long-term strategy according to the corporate roadmap, and select recommended talent based on whether the specific capabilities can be achieved from the capability-development skill-tree of each candidate.

In addition, the processor updates a required talent list according to changes in corporate strategy on the corporate roadmap and changes in the candidates' career histories.

In addition, the processor predicts the type and number of talent needed by year according to the corporate roadmap and industry trends.

In addition, the corporate-provided data may include at least one of a business plan, a technology roadmap, and an organizational expansion plan.

The apparatus and method for predicting required talent based on a corporate roadmap according to an embodiment integrates and structures various internal data such as a corporate's business plan, technology roadmap, organizational expansion plan, etc., thereby predicting key job roles and technical domains needed in the future.

In addition, the apparatus and method for predicting required talent based on a corporate roadmap according to an embodiment enables objective and data-centric required talent prediction based on an AI algorithm without relying on existing empirical judgment. For example, it allows an automobile company aiming to develop autonomous vehicles to pre-hire and train autonomous driving software developers and AI engineers in line with specific milestones.

In addition, through the embodiment, emergency personnel hiring due to rapid market changes can be reduced, thereby increasing the efficiency of corporate operations.

In addition, through the embodiment, customized required talent by corporate growth stage is predicted, so that talent suitable for the stage can be predicted and prepared in advance according to different talent types required by corporate growth stage (initial, growth, maturity).

In addition, through the embodiment, in the initial stage, research and development (R&D) talent, in the growth stage, sales talent related to market expansion, and in the maturity stage, data analysis talent for operational optimization, etc., can be secured. In the case of a startup corporate, development personnel is important in the initial stage, and marketing and sales talent is important in the growth stage, so required talent by growth stage can be secured in advance through this system.

In addition, through the embodiment, required talent can be adjusted according to the corporate's growth speed, thereby preventing personnel surplus or personnel shortage phenomena.

In addition, through the embodiment, by clarifying talent requirements aligned with milestones of the corporate roadmap, roadmap-based goal-oriented talent management is enabled. Through this, required job roles and skills are clarified in line with major milestones such as specific product launch dates, project completion points, etc., thereby coordinating the type of required talent and talent securing schedule. In addition, through the embodiment, problems of project delays due to failure to secure required talent in time can be prevented. In addition, through the embodiment, a semiconductor manufacturer secures specific engineers (equipment engineers, process engineers, etc.) in advance in line with the fine process development schedule, thereby supporting pre-hiring and training of suitable talent in line with specific milestones.

In addition, since required job roles and skills also fluctuate in line with technological advancements or industry changes, through the embodiment, talent requirements can be automatically updated whenever the corporate's strategy changes or technology trends change.

In addition, talent securing strategies can be adjusted to meet new job requirements by agilely responding to technology changes.

In addition, through the embodiment, long-term talent pool management and pre-securing of future talent enable stable supply of core talent by securing required talent in advance in line with the corporate's mid-to long-term growth strategy. In addition, through the embodiment, talent needed at a specific point in time can be prepared in advance, thereby preventing emergency hiring situations and resolving talent supply-demand imbalances.

In addition, through the embodiment, skills and career changes of talent registered in the talent pool are tracked in real time, thereby proactively securing candidates suitable for specific job roles.

In addition, through the embodiment, personalized career development is supported by visualizing a talent's capability-development skill-tree.

In addition, through the embodiment, skills, certifications, experiences, etc., required for candidates and employees to reach a specific career stage (e.g., project leader, department head) are visualized, thereby presenting clear career development goals, and providing clear growth paths to talent desiring job promotion or career transition, thereby strengthening employee engagement and motivation.

In addition, through the embodiment, a virtuous cycle structure in which employees and the corporate grow together is built by connecting the corporate's mid- to long-term strategy and employees' career goals, and when employees recognize that their career growth path aligns with the company's roadmap, turnover intention decreases and engagement improves.

In addition, through the embodiment, existing employees transition to new job roles through job transition education, thereby reducing external hiring costs.

The effects obtainable from the exemplary embodiments of the present disclosure are not limited to the effects mentioned above, and other effects not mentioned can be clearly derived and understood by those skilled in the art in the technical field to which the exemplary embodiments of the present disclosure belong from the following description. That is, unintended effects from implementing the exemplary embodiments of the present disclosure can also be derived by those skilled in the art from the exemplary embodiments of the present disclosure.

### BRIEF DESCRIPTION OF THE DRAWINGS

FIG. 1 is a diagram illustrating a system for predicting required talent based on a corporate roadmap according to an embodiment.

FIG. 2 is a diagram illustrating an apparatus for predicting required talent based on a corporate roadmap according to an embodiment.

FIG. 3 is a diagram illustrating a process for predicting required talent based on a corporate roadmap according to an embodiment.

### DETAILED DESCRIPTION OF EXEMPLARY EMBODIMENTS

Hereinafter, various embodiments of the present disclosure are described in connection with the accompanying drawings. The various embodiments of the present disclosure may be subject to various modifications and may have various embodiments, with specific embodiments illustrated in the drawings and related detailed descriptions provided. However, this is not intended to limit the various embodiments of the present disclosure to specific forms, and it should be understood to include all changes and/or equivalents or substitutes included in the spirit and technical scope of the various embodiments of the present disclosure. In connection with the description of the drawings, similar reference numerals have been used for similar components.

In various embodiments of the present disclosure, terms such as “include” or “have” are intended to designate the existence of features, numbers, steps, operations, components, parts, or combinations thereof described in the specification, and should be understood not to preclude in advance the possibility of the existence or addition of one or more other features, numbers, steps, operations, components, parts, or combinations thereof.

In various embodiments of the present disclosure, expressions such as “or” include any and all combinations of the words listed together. For example, “A or B” may include A, may include B, or may include both A and B.

Expressions such as “first,” “second,” “primary,” and “secondary” used in various embodiments of the present disclosure may modify various components of the various embodiments but do not limit the corresponding components. For example, the above expressions do not limit the order and/or importance of the corresponding components and may be used to distinguish one component from another.

When a component is mentioned as being “connected” or “coupled” to another component, the component may be directly connected or coupled to the other component, but it should be understood that one or more other components may exist between the component and the other component.

Terms such as “module,” “unit,” “part,” etc., in embodiments of the present disclosure are terms referring to a component that performs at least one function or operation, and such a component may be implemented as hardware or software or a combination of hardware and software. In addition, a plurality of “modules,” “units,” “parts,” etc., may be integrated into at least one module or chip and implemented as at least one processor, except where each needs to be implemented as individual specific hardware.

Terms such as those defined in a commonly used dictionary should be interpreted as having meanings consistent with the meanings in the context of the related art, and unless explicitly defined in various embodiments of the present disclosure, should not be interpreted in ideal or excessively formal meanings.

Hereinafter, embodiments of the present disclosure will be described in detail with reference to the accompanying drawings.

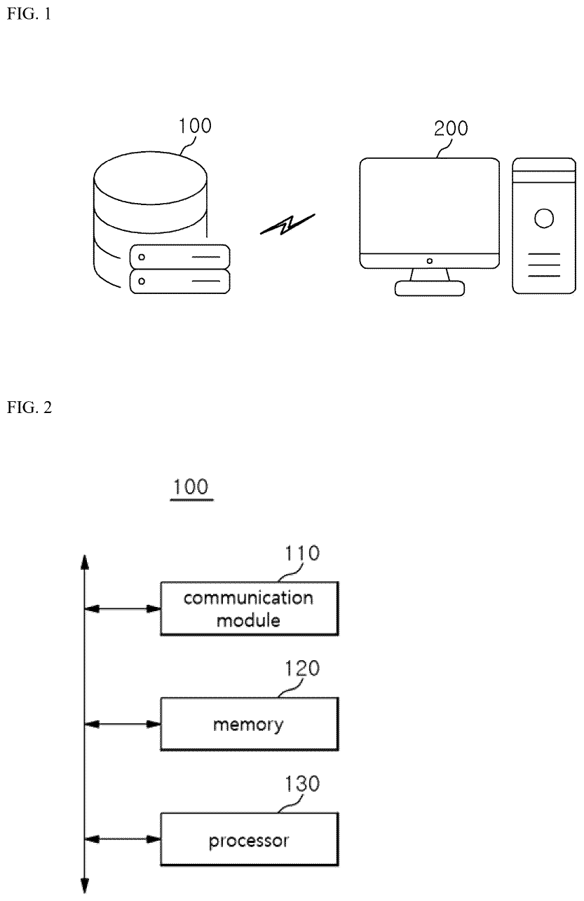

FIG. 1 is a diagram illustrating a system for predicting required talent based on a corporate roadmap according to an embodiment.

Referring to FIG. 1, a system for predicting required talent based on a corporate roadmap according to an embodiment may be configured to include a prediction apparatus (100) and a corporate terminal (200). In the embodiment, the corporate terminal (200) is a terminal of various corporates that request prediction of required talent based on a corporate roadmap. In the embodiment, the corporate terminal (200) transmits corporate-provided data to a server (100). In the embodiment, the corporate-provided data is various materials and information of the corporate necessary for required talent prediction, including a business plan, a technology roadmap, an organizational expansion plan, and the like, but is not limited thereto.

The prediction apparatus (100) collects corporate-provided data from the corporate terminal (200), structures it, and analyzes the corporate roadmap through an artificial intelligence model based on the structured corporate-provided data. Thereafter, the prediction apparatus (100) identifies key job roles and technical domains that the corporate will need in the future according to the analysis result.

The apparatus and method for predicting required talent based on a corporate roadmap according to an embodiment systematically structures various data provided by a corporate. In the embodiment, the corporate-provided data includes, for example, a business plan, a technology roadmap, an organizational expansion plan, and the like, but is not limited thereto. In the embodiment, the corporate-provided data is analyzed through artificial intelligence, and key job roles and technical domains that the corporate will need in the future are identified according to the analysis result. For example, in the embodiment, if there is a goal in the technology roadmap of “commercialization of autonomous driving technology in 3 years,” the engineering and research and development (R&D) capabilities necessary for the technology are predicted. In addition, if “overseas market entry” is a goal in the business expansion plan, language proficiency and international business experience are determined to be important.

In addition, in the embodiment, demand analysis by corporate growth stage is performed. In the embodiment, after identifying which stage the corporate is in, such as initial, growth, maturity, etc., talent suitable for the stage can be predicted. In the embodiment, if it is determined that the corporate is in the initial stage, since it is in a startup state, it is determined to prefer flexible talent. If it is determined that the corporate is in the growth stage, talent with leadership and expertise capable of managing organizational expansion is determined to be necessary. In addition, if it is determined that the corporate is in the maturity stage, top-level experts capable of strengthening global competitiveness are identified as necessary. In addition, the apparatus and method for predicting required talent based on a corporate roadmap according to an embodiment analyzes new technology trends in the industry, market changes, etc., in connection with industry trends to predict job roles and skills suitable for the corporate roadmap.

In addition, the apparatus and method for predicting required talent based on a corporate roadmap according to an embodiment specifies required talent based on important milestones in the corporate roadmap. In the embodiment, milestones include new product launches, addition of new business divisions, and the like, but are not limited thereto. Specifically, in the embodiment, if there is a milestone of “introducing new technology in 2 years,” it is determined that research engineers are needed before introduction and technology implementation experts are needed after introduction.

In addition, the apparatus and method for predicting required talent based on a corporate roadmap according to an embodiment continuously updates a recommended talent list according to changes in corporate strategy including goal adjustments and technology changes, and changes in the candidates' career histories. In the embodiment, career changes include acquisition of new skills, career transitions, and the like, but are not limited thereto. For example, the artificial intelligence model provided in the embodiment reflects a candidate's newly acquired certifications or project experience and re-evaluates whether it matches the talent requirements targeted by the corporate.

In addition, the apparatus and method for predicting required talent based on a corporate roadmap according to an embodiment performs long-term talent pool management. In the embodiment, talent needed at a specific point in time can be secured in advance according to the corporate roadmap and industry trends. For example, candidates suitable for “job roles needed in 3 years” can be discovered from now, nurtured, or added to the talent pool.

In addition, the apparatus and method for predicting required talent based on a corporate roadmap according to an embodiment performs customized matching of a talent's capability-development skill-tree with the corporate roadmap and visualizes a personalized growth path. In the embodiment, skills, certifications, experiences, etc., required for a candidate to reach a specific career stage (e.g., project leader, department head) can be visualized in a skill-tree format. Specifically, the apparatus and method for predicting required talent based on a corporate roadmap according to an embodiment can present that for a candidate who is currently a data analyst to become a data science team leader, “machine learning modeling,” “project leading experience,” etc., are needed, and present such a path.

In addition, the apparatus and method for predicting required talent based on a corporate roadmap according to an embodiment performs matching with the corporate roadmap, thereby connecting specific capabilities required in the corporate's mid- to long-term strategy with growth potential on an individual skill-tree. For example, if a corporate plans “introduction of blockchain-based technology within 5 years,” AI recommends candidates who are learning blockchain technology and allows presentation of the gap between the candidate's current position and the capabilities required by the corporate.

In addition, through the embodiment, a corporate secures talent needed in the medium to long term, and a candidate obtains customized opportunities that can support their own career growth. Through the embodiment, if a candidate acquires necessary skills through educational opportunities provided by the corporate, a virtuous cycle structure in which both the corporate and the candidate grow is created. This invention provides long-term value to both the corporate and the candidate and presents a new headhunting paradigm that goes beyond the existing short-term vacancy filling method.

FIG. 2 is a diagram illustrating the configuration of a prediction apparatus according to an embodiment.

In the embodiment, the prediction apparatus (100) may be configured as a server. In the embodiment, a server is a computing system in a computer network that provides services to or stores and manages data for other computers or devices. A server accepts requests from other computers or devices called clients and provides responses or data for the requests. The configuration of the prediction apparatus (100) shown in FIG. 2 is merely a simplified example.

The communication module (110) may be configured regardless of its communication mode, such as wired or wireless, and may be configured with various communication networks such as a Personal Area Network (PAN), a Local Area Network (LAN), etc. In addition, the communication module (110) may operate based on the known World Wide Web (WWW) and may use wireless transmission technology used for short-range communication such as Infrared Data Association (IrDA) or Bluetooth. For example, the communication module (110) may be responsible for transmitting and receiving data necessary to perform the technique according to an embodiment of the present disclosure.

The memory (120) may refer to any type of storage medium. For example, the memory (120) may include at least one type of storage medium among flash memory type, hard disk type, multimedia card micro type, card type memory (e.g., SD or XD memory, etc.), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. Such a memory (120) may also constitute the database shown in FIG. 1.

The memory (120) may store at least one instruction that can be executed by the processor (130). In addition, the memory (120) may store any form of information generated or determined by the processor (130) and any form of information received by a server. In addition, the memory (120) stores various kinds of modules, instruction sets, or models.

The processor (130) may perform technical features according to embodiments of the present disclosure to be described later by executing at least one instruction stored in the memory (120). In one embodiment, the processor (130) may be configured with at least one core and may include a processor for data analysis and/or processing such as a central processing unit (CPU), a general purpose graphics processing unit (GPGPU), a tensor processing unit (TPU), etc., of a computer device.

Such a processor (130) can train a neural network or model designed in a machine learning or deep learning manner. To this end, the processor (130) can perform calculations for training the neural network, such as processing of input data for training, feature extraction from input data, error calculation, and updating of weights of the neural network using backpropagation. In addition, the processor (130) may perform inference for a predetermined purpose using a model implemented in an artificial neural network manner.

In the embodiment, the processor (130) structures corporate-provided data, analyzes the structured corporate-provided data through an artificial intelligence model, and identifies future key job roles and technical domains of the corporate according to the analysis result. In the embodiment, the future key job roles and technical domains are job roles and technical domains required according to the corporate roadmap. To this end, the processor (130) collects corporate-provided data provided by the corporate as input data. In the embodiment, the corporate-provided data includes a technology roadmap, a business plan, an organizational expansion plan, and the like, but is not limited thereto. In the embodiment, the input data may be provided in the form of PDF, Word, Excel, and database as corporate-provided data. In the embodiment, if the input data is unstructured data, the processor (130) converts it to text data through Optical Character Recognition (OCR) technology.

Thereafter, unnecessary characters, spaces, and duplicate data are removed through a text purification process.

Thereafter, the processor (130) performs data structuring. In the embodiment, the processor (130) separates text data extracted from documents into meaningful units using tokenization and syntax analysis techniques. Thereafter, major goals and related skills are identified using keyword extraction algorithms (TF-IDF, Word2Vec, BERT). Thereafter, data is structured by time horizon and goal unit. For example, the processor (130) can structure data of “commercialization of autonomous driving technology in 3 years” as goal: commercialization of autonomous driving technology, period: 3 years.

In the embodiment, the processor (130) designs an analysis model for artificial intelligence-based data analysis. In the embodiment, the analysis model is an artificial neural network model that receives structured corporate-provided data, identifies characteristics of talent needed by the corporate, capabilities of the talent, and the corporate growth stage, and outputs them. In the embodiment, the processor (130) can set corporate-provided data and correct answer data for the corporate-provided data as a training data set and train the analysis model through the set training data set. In the embodiment, the processor (130) can design a hybrid AI model combining a natural language processing (NLP) model and time series analysis. At this time, the processor (130) can use BERT, GPT, and Prophet models. Thereafter, the processor (130) derives necessary job roles and technical capabilities according to major milestones extracted from roadmap data through the designed artificial intelligence model. For example, the processor (130) can analyze data of “commercialization of autonomous driving technology in 3 years” with the artificial intelligence model and extract necessary capabilities as autonomous driving software development, sensor data analysis, and R&D leadership.

Thereafter, the model analyzes which stage the corporate is in among initial (Start-Up), growth (Growth), and maturity (Maturity). Thereafter, it recommends talent types required for each stage. For example, in the case of the initial stage, versatile and flexible talent is recommended as talent needed by the corporate, and in the case of the growth stage, talent with leadership capabilities capable of managing organizational expansion can be recommended as necessary. In addition, in the maturity stage, experts capable of strengthening global competitiveness can be recommended as required talent.

In addition, the processor (130) focuses on analyzing major milestones through the model for timed customized talent recommendation. For example, the model can specify required talent based on important milestones in the corporate roadmap. In the embodiment, milestones are goal information of the corporate, including new product launches, overseas market entry, and the like, but are not limited thereto. For example, if the model identifies “introduction of new technology in 2 years” as a milestone, it can extract required talent as research engineers before introduction and recommend technology implementation experts after introduction.

In addition, the analysis model according to an embodiment performs dynamic recommendation and update. For example, it automatically updates the talent list according to changes in corporate strategy such as goal adjustment and technology changes, or candidate career changes. In the embodiment, candidate career changes include certifications acquisition, project completion, and the like, but are not limited thereto. Specifically, the analysis model updates certifications acquisition information when a candidate newly acquires a machine learning certifications and can recommend it for job roles requiring “machine learning-based data analysis.”

In addition, the processor (130) matches the corporate roadmap and talent growth skill-tree using the analysis model. To this end, the processor (130) visualizes a personalized growth path. For example, the analysis model can provide skills and experiences necessary for a candidate to reach a specific career stage (e.g., team leader, department head) in a skill-tree format. Specifically, if a specific candidate desires growth from a data analyst to a data science team leader, the analysis model extracts required skills as machine learning modeling and project leading experience, and can propose “machine learning certifications course” followed by “team project leading” as a growth path.

In addition, in the embodiment, the processor (130) connects the growth path to corporate-required capabilities. To this end, the processor (130) compares technology capabilities required in the corporate roadmap with the candidate's current state. For example, it can match a corporate with “blockchain technology introduction (within 5 years)” in the corporate roadmap and a candidate learning blockchain.

Through the embodiment, a corporate can efficiently manage talent by discovering required talent in the medium to long term in advance. In addition, candidates can clearly identify their individual career growth paths and form a win-win relationship with the corporate. Unlike existing short-term hiring methods, it strengthens corporate competitiveness through mid- to long-term prediction-based talent recommendation.

In addition, the processor (130) determines the corporate's growth stage through corporate-provided data and corporate roadmap analysis, and predicts talent necessary for the corporate based on the determined corporate growth stage. In the embodiment, the processor (130) predicts required talent corresponding to corporate-specific future key job roles and technical domains based on the determined corporate growth stage. To this end, the processor (130) receives and formalizes corporate-provided data such as technology roadmap, business plan, organizational expansion plan, financial report, investment report, etc. In addition, it performs data preprocessing such as removing spaces, special characters, and duplicate sentences. Thereafter, the processor (130) extracts important keywords related to corporate goals, skills, and organizational expansion using natural language processing (NLP) technology and analyzes data for determining corporate growth stage. In the embodiment, the processor (130) determines it as the initial (Start-up) stage if characteristics associated with keywords such as “new market entry,” “technology development in progress,” “investment attraction in progress” are detected more than a certain number of times through a growth stage characteristic database. In addition, it determines it as the growth (Growth) stage if phrases such as “business expansion,” “new product launch,” “overseas entry,” “market share expansion” are detected more than a certain number of times. In addition, it can determine it as the maturity (Maturity) stage if goals such as “global entry,” “advancement,” “overseas branch establishment,” “new technology introduction” are detected more than a certain number of times.

Thereafter, the processor (130) designs a growth stage prediction model. In the embodiment, an NLP-based growth stage analysis model can be designed. In the embodiment, keywords appearing in the business plan and technology roadmap can be vectorized (Word2Vec, BERT) through a natural language processing (NLP) algorithm and matched with characteristics of growth stages to implement the analysis model. In the embodiment, the analysis model may be composed of Logistic Regression, XGBoost, and deep learning model (Transformer-based). In the embodiment, the processor (130) can use a multi-classification model that predicts growth stages (initial, growth, maturity) from input data with the analysis model. In the embodiment, characteristic data includes text keywords and financial data. Text keywords include “market entry,” “technology development,” “organizational expansion,” etc., and financial data may include sales growth rate, new investment attraction status, annual employment growth rate, etc.

Thereafter, the processor (130) inputs keywords extracted from roadmap data into the growth stage classification algorithm of the analysis model. Thereafter, it can classify into one of initial (0), growth (1), and maturity (2) stages with a Softmax activation function. Thereafter, the processor (130) extracts required talent types and example job roles by corporate growth stage. For example, in the case of a corporate in the initial (Start-up) stage, it identifies that versatile talent is needed, and the example job roles can be extracted as versatile roles such as software engineer, product manager, marketing expert, etc.

In addition, for a corporate in the growth (Growth) stage, it identifies specialized leaders and management talent as required talent, and can extract job roles requiring leadership capabilities such as project manager (PM), team leader, engineering leader, etc., as example job roles.

In addition, in the case of the maturity (Maturity) stage, it determines advanced experts and global experts as required talent, and can identify global marketing experts, overseas branch managers, advanced R&D talent, etc., as example job roles.

In the embodiment, the analysis model can use a required talent prediction algorithm by growth stage and an artificial intelligence-based prediction model together. This is using a rule-based algorithm that maps required job roles and talent types according to growth stages together with an AI-based prediction model.

In addition, the processor (130) specifies required talent by growth stage based on milestones that are goals by growth stage of the corporate roadmap. Through the processor (130), required talent types and technology capabilities are specified based on intermediate goals (milestones) extracted from the corporate roadmap.

In addition, required talent requirements are dynamically updated according to corporate roadmap changes (goal addition, schedule adjustment, etc.) or candidate career changes (certifications acquisition, new technology acquisition). In the embodiment, the processor (130) predicts job roles, skills, and capabilities necessary for each milestone of the corporate with an artificial intelligence model, matches them with candidates registered in the talent database, and recommends optimal talent. To this end, the processor (130) preprocesses corporate-provided data, extracts keywords, and analyzes syntax. In the embodiment, important keywords related to corporate goals, skills, and organizational expansion are extracted using natural language processing (NLP) technology. Thereafter, milestones are identified and structured. In the embodiment, the processor (130) recognizes phrases with clear timelines and goals, such as “new product launch,” “commercialization of autonomous driving technology within 2 years,” “blockchain technology introduction,” as milestones. Thereafter, timeline information such as “in 2 years,” “Q3 2025,” “within 6 months” is extracted from documents through natural language understanding models such as BERT and Word2Vec to identify milestone schedule information. Thereafter, the processor (130) structures and stores information such as goals, periods, required skills, and required job roles of each milestone in a database. Thereafter, the processor (130) specifies talent types necessary for each milestone. To this end, the processor (130) analyzes milestones included in the roadmap according to schedules and goals. In the embodiment, major goal types include new technology introduction, new product launch, overseas entry, and the like, but are not limited thereto. New technology introduction includes, for example, blockchain, AI/ML technology introduction, etc., and job roles necessary for new technology introduction are research and development (R&D) engineers, system architects, etc. New product launch includes product design, prototype production, etc., and job roles necessary for new product launch may include product designers, quality assurance (QA) engineers, etc. Overseas entry includes new market entry, overseas corporation establishment, etc., and job roles necessary for overseas entry may include overseas marketing experts, overseas legal experts, etc. Thereafter, the processor (130) performs natural language processing (NLP) to extract job keywords (engineer, designer, research engineer, etc.) related to milestone goals. Thereafter, optimal job roles and capabilities are selected by comparing job and capability data suitable for milestones with industry standard databases (O*NET, ESCO, etc.).

At this time, the processor (130) uses a BERT-based job and technology mapping algorithm for required talent specification, predicts required job roles and capabilities according to milestones with a model, vectorizes job roles and required skills, and converts them into talent requirements.

In addition, the processor (130) generates a capability-development skill-tree according to individual information of each candidate. In the embodiment, the generated capability-development skill-tree is matched with the corporate roadmap, and a company-specific recommended talent list is generated from among the matching candidates. To this end, the processor (130) collects not only basic personal information of candidates (e.g., name, age, education, etc.) but also user information such as career information, technology capabilities, certifications, hobbies, and interests. In addition, candidate's technology level, problem-solving ability, collaboration ability, etc., are quantitatively measured through capability evaluation. Thereafter, the processor (130) analyzes capabilities possessed by the candidate and lacking capabilities based on the collected information. Through this, a customized capability-development skill-tree is generated according to the candidate's individual career goals and suitable industries. The skill-tree visually represents the correlation and priority between each capability and systematically presents the candidate's growth potential and path. Thereafter, the processor (130) analyzes the corporate's mid- to long-term roadmap (e.g., technology development goals, business expansion plans, organizational capability strengthening strategies, etc.) and matches it with the candidate's capability-development skill-tree. In this process, how well specific capabilities required by the corporate (e.g., expertise in specific skills, multinational project experience, etc.) match the capabilities on the candidate's skill-tree is evaluated. Thereafter, the processor (130) selects candidates that meet the capabilities and suitability needed by the corporate based on the matching results. The selected candidates are classified according to priority, and a customized recommended talent list is generated according to the corporate's requirements. This list may be provided by comprehensively considering the candidate's matching score, growth potential, career path, etc.

In addition, the processor (130) can adjust required talents in real time according to roadmap changes and talent information updates. In the embodiment, the database is automatically updated when roadmap changes such as new milestone addition or schedule changes occur. In addition, when a candidate acquires a new certifications or career changes occur, re-analysis is automatically performed. Thereafter, talent is automatically matched to milestones, and optimal candidates are recommended from the talent database based on job roles and capabilities required for milestones.

In addition, the processor (130) updates the recommended talent list according to changes in corporate strategy and changes in the candidates' career histories. To this end, the processor (130) extracts goals, schedules, and milestone changes from documents through syntax analysis. Thereafter, new added goals, modified goals, schedule changes, etc., are extracted through a change detection algorithm using a natural language processing (NLP) model. In addition, in the embodiment, document differences before and after changes are compared using BERT or GPT models, and differences (Diff) are calculated. In addition, the processor (130) structures and stores changed milestones, schedules, goals, etc., in a database.

Thereafter, the processor (130) automatically detects candidate career changes and structures data. To this end, the processor (130) collects and preprocesses candidate data. At this time, input data may include candidate's resume, certifications information, online profile (LMS, MOOC learning history), project history database, etc. In the embodiment, the analysis model detects resume updates and extracts new career items. In addition, new certifications acquisition information is automatically collected by connecting to the certifications issuing institution's database. In addition, candidate's learning history is tracked in real time by connecting to online learning platforms (MOOC) or in-house education systems. Thereafter, the processor (130) structures and stores changed resume data, certifications data, learning data, etc., in a database. Thereafter, the processor (130) updates the talent list in real time according to corporate strategy and candidate career changes. In addition, the processor (130) extracts corporate milestone goals, required job roles, and technology capabilities for corporate talent requirement matching. For example, the processor (130) dynamically matches candidate's resume, certifications, learning history, and corporate talent requirements.

In the embodiment, job roles and required skills are converted into vectors (BERT or Word2Vec), similarity between job roles and candidate's resume is calculated. In addition, a recommended talent list is generated in order of candidates with high similarity, and the recommended list is automatically updated.

In addition, the processor (130) automatically updates required talent requirements when corporate requirements change. In addition, if a candidate's career changes due to newly acquiring a certifications or learning a new technology, the candidate is automatically added as talent suitable for a new milestone.

Through this, when the corporate roadmap changes or candidate's career changes, the recommended talent list is automatically renewed, supporting the corporate's rapid talent securing.

In addition, optimal talent can be recommended through artificial intelligence-based career analysis and matching algorithms. In addition, roadmap changes and career data changes can be automatically detected, and required job roles and talent requirements can be updated in real time.

In addition, the processor (130) predicts the type and number of required talent by year according to the corporate roadmap and industry trends. To this end, the processor (130) structures data by analyzing the corporate roadmap and industry trends. In the embodiment, major goals, schedules, technology goals, and organizational expansion schedules are extracted through text purification and syntax analysis. In addition, variables are defined and data is structured. In the embodiment, variables may include goal type, required job roles, required capabilities, etc. Goal types include new technology introduction, new product launch, organizational expansion, overseas entry, etc., and required job roles may include engineers, R&D researchers, developers, marketing experts, etc. Required capabilities may include technology capabilities, certifications, project experience, etc. In addition, the processor (130) collects and analyzes industry trend data. In the embodiment, industry reports, market research reports, technology trend reports, economic indicators, and job posting data can be analyzed. In addition, new technology trends (e.g., AI, blockchain, metaverse, etc.) are detected using a natural language processing (NLP) model. In addition, new job appearance frequency and technology requirements are extracted from industry required talent data (job posting data) to perform data analysis and modeling for required talent prediction.

Thereafter, the processor (130) predicts annual required talent based on the corporate roadmap and industry trends. In the embodiment, characteristics of analysis data are extracted, and required talent prediction variables are generated. In the embodiment, major input variables may include corporate technology goals and schedules (e.g., completion of autonomous driving software development in Q 2 2024), industry trends (e.g., increasing adoption rate of blockchain technology, expanding hiring demand for AI technology), past required talent data (corporate's past hiring data, job demand data of similar corporates), etc.

Thereafter, the processor (130) trains the analysis model. In the embodiment, the processor (130) can design the analysis model with ARIMA, Prophet, LSTM (Long Short-Term Memory) algorithms, etc., to predict annual required talent. Thereafter, required job roles and talent numbers are predicted using machine learning models such as XGBoost, Random Forest, and Gradient Boosting Machine (GBM). In addition, prediction is performed using past required talent, technology trends, roadmap schedules, etc., as input variables of a regression model.

In addition, when the roadmap is updated, the AI model automatically retrains to dynamically update required talent prediction information and reflect industry trends. In the embodiment, when industry technology trends change, job demand and technology capability requirements are automatically updated. Thereafter, annual required talent prediction results are generated and visualized. In the embodiment, the processor (130) calculates required job roles and talent numbers by year to predict and visualize annual required talent. In addition, required job roles and required talent numbers by job position are specified by year. Thereafter, annual job-specific talent number prediction information is visualized on a dashboard. In the embodiment, annual required talent numbers can be represented through bar charts, and changes in required talent between job roles and years can be represented through heatmaps.

In addition, in the embodiment, a corporate dashboard is provided, so that corporate users can check annual required talent in real time through a web interface dashboard.

In addition, the processor (130) generates a capability-development skill-tree according to individual information of each talent, matches the generated capability-development skill-tree with the corporate roadmap, and can visualize the matched roadmap and talent's capability-development skill-tree. To this end, a personalized capability-development skill-tree is generated based on talent's career, technology capabilities, and certifications information through the processor (130). Thereafter, the processor (130) matches the generated talent's capability-development skill-tree to the corporate roadmap to induce growth of talent meeting the corporate's requirements. In addition, the matched talent's skill-tree and corporate roadmap are visualized with an intuitive graphic interface so that talent and the corporate can clearly recognize the difference between talent growth path and roadmap.

In the embodiment, for generating talent's capability-development skill-tree, the processor (130) first collects and preprocesses talent data. At this time, collected data may include resume data including job history, career, position, technical capabilities, certifications data including acquired certifications names, acquisition dates, and issuing institutions, education data including education platform (LMS, MOOC) learning history and project history, etc.

Thereafter, text data among the collected data is analyzed with a BERT-based natural language processing model to extract job titles, technology names, certifications names, and project names. Thereafter, the processor (130) generates nodes based on the extracted keywords. In the embodiment, the current job position of the talent is set as a start node. Thereafter, a target node is set. In the embodiment, the target node is set to a job position required by the corporate (e.g., data science team leader). Thereafter, the processor (130) performs path exploration and generates a skill-tree. Skills, certifications, experiences, and projects necessary to move from the current job position to the target job position are added as nodes. In addition, an optimal growth path is generated by exploring the shortest path with AI algorithms (BFS, DFS). Thereafter, the skill-tree is structured and stored in a database. Skill-tree data is stored in a graph database (Neo4j) to structure node and edge information.

Thereafter, the processor (130) matches the talent skill-tree with the corporate roadmap.

To this end, the processor (130) collects and analyzes corporate roadmap data. At this time, the collected data includes the corporate's technology roadmap, organizational expansion plan, technology goal reports, and the like, but is not limited thereto.

Thereafter, the processor (130) performs a roadmap matching algorithm. In the embodiment, job roles and skills suitable for goals specified in the roadmap (e.g., “completion of autonomous driving software development in 2026”) are extracted. Thereafter, they are matched with the skill-tree. In the embodiment, the processor (130) compares the job position required by the corporate (autonomous driving engineer) with the target node of the talent skill-tree to calculate additional capabilities necessary for the talent to reach the target job position.

Thereafter, the processor (130) visualizes the skill-tree and roadmap. To this end, the processor (130) uses a graph visualization engine. In the embodiment, visualization libraries such as D3.js and Cytoscape. js are utilized to visualize the skill-tree and roadmap in graph form. In addition, the processor (130) provides a visual representation of the skill-tree.

For example, the visual representation may include circular nodes, edges, etc. Circular nodes display the talent's job roles, technology capabilities, and certifications as nodes, and edges connect paths between job roles to clearly express the talent's path. In addition, the processor (130) visualizes a comparison between the corporate roadmap and the skill-tree. In the embodiment, the corporate's goal nodes are displayed as major milestones of the roadmap. In addition, the gap between the talent's current node and target node is visualized to clearly present the difference in necessary capabilities. For example, if the current position is a data analyst and the goal is a data science team leader, lacking capabilities can be output as “machine learning modeling,” “project leading,” etc.

Through the embodiment, by matching the corporate roadmap with the talent's capability-development skill-tree, talent nurturing tailored to the corporate's needs can be supported. In addition, talent can visually confirm their own career growth path, thereby presenting a personalized career development path.

In addition, through the embodiment, by visualizing the talent skill-tree and roadmap, corporates and talent can intuitively recognize the difference between talent development and roadmap goals.

In addition, the processor (130) visualizes skills, certifications, and experiences necessary for talent to reach a specific career stage in a development skill-tree. A development skill-tree that clearly presents a growth path from the current job position to the target job position is generated by analyzing the talent's career data through the processor (130). To this end, skills, certifications, and experiences required to reach the target job position are visualized in skill-tree form so that talent can intuitionally recognize the career development path. In addition, the processor (130) promotes talent's career development by presenting step-by-step learning paths and practical experience paths to reach the target job position. In addition, the processor (130) analyzes skills, certifications, and experiences necessary to reach the talent's career stage and generates a skill-tree. To this end, the processor (130) collects and preprocesses the talent's career information. In the embodiment, collected data may include resume information, certifications information, and learning data. Thereafter, job titles, certifications names, technology names, and project names are extracted through a natural language processing (NLP) algorithm. Thereafter, the processor (130) analyzes the career development path. Thereafter, a target career stage is set. In addition, a target job position (e.g., data science team leader) is defined, and skills, certifications, and experiences required for the target job position are identified. In the embodiment, the identified information is connected to the corporate's job requirement database (O*NET, ESCO, etc.) to automatically extract capabilities necessary for the target job position. Thereafter, the processor (130) analyzes the difference between current capabilities and target capabilities. In the embodiment, additional skills, certifications, and experiences necessary between the current job position (data analyst) and the target job position (data science team leader) are identified.

In addition, lacking capabilities are extracted and added as nodes to generate a skill-tree. In addition, the processor (130) generates nodes. For example, the talent's current job position is set as a start node, and the target job position is set as a target node. In addition, paths (edges) between nodes are connected. In the embodiment, skills, certifications, and experiences to be added on the path are added as nodes, and connection relationships between them are defined. Thereafter, the processor (130) structures and stores node and edge information in a graph database (Neo4j).

Specifically, the processor (130) generates a skill-tree layout including a central node, a final target node, intermediate nodes, and path visualization for skill-tree graph visualization. In the embodiment, the central node includes the current job position (e.g., data analyst), the final target node includes the target job position (e.g., data science team leader), intermediate nodes add required skills, certifications, and experiences as intermediate nodes, and path (edge) visualization displays paths connecting from the start job position to the target job position with arrows to clearly recognize the talent's career development path. Thereafter, colors and states are displayed in the layout.

Completed capabilities can be displayed as green nodes, and additionally required capabilities can be displayed as red. Capabilities in progress can be displayed as yellow.

Users (talent) can check their career development skill-tree on a dashboard, and by clicking each node, they are directly connected to related learning materials (online lectures, education courses). Through this, career development visualization for talent: skills, certifications, and experiences necessary to reach the target job position can be visually grasped, enabling clear recognition of the career development path. In addition, by connecting talent's history and corporate requirements, a personalized growth path is provided, and the gap between current state and target state can be clearly recognized through an intuitive skill-tree graph. In addition, talent can clearly recognize which certifications to acquire and which experiences to accumulate by referring to the skill-tree, thereby accelerating career growth.

In addition, the processor (130) matches specific capabilities required in the corporate's mid- to long-term strategy with growth potential on an individual skill-tree. In the embodiment, the processor (130) evaluates growth potential by matching core job roles and capabilities required in the corporate's mid- to long-term strategy with the individual's skill-tree. In addition, by matching the individual's capability-development skill-tree with the corporate's strategy, it specifically presents which skills the individual should learn and which certifications to acquire. In addition, the individual skill-tree and corporate roadmap are visualized in graph form so that talent and the corporate can clearly recognize the difference with the target job position.

In the embodiment, the processor (130) derives required job roles and capabilities by analyzing the corporate's mid- to long-term roadmap. In the embodiment, job roles and capabilities required by the corporate are extracted from technology roadmap, organizational expansion plan, business plan, etc., through natural language processing (NLP) algorithms (BERT, GPT, etc.). The technology roadmap includes technology introduction schedules, technology requirements, and new skills, the organizational expansion plan includes new department establishment schedules and new job creation plans, and the business plan includes new product launch schedules and new market entry strategies. Thereafter, the processor (130) derives mid- to long-term strategy analysis and milestones. Thereafter, mid- to long-term goals are analyzed. For example, from the goal “construction of blockchain-based supply chain management system in 2026,” “blockchain” and “supply chain management system” can be extracted as required capabilities. Thereafter, the processor (130) analyzes required capabilities based on milestones. Required job roles and required skills are structured by milestone. To this end, a required capability database is created. In the embodiment, the processor (130) stores required job roles, capabilities, certifications, and skills in a database to use as reference data that can be compared with the talent's skill-tree. Thereafter, individual capability-development skill-tree generation and growth potential analysis are performed.

In addition, the processor (130) generates a capability-development skill-tree based on the individual's career information and evaluates growth potential. To this end, individual data is collected and preprocessed. Thereafter, individual resume data is analyzed with natural language processing (NLP) to extract job titles, technology names, certifications names, and project names. In addition, a capability-development skill-tree is generated. In addition, the path from the current job position (e.g., data analyst) to the target job position (e.g., data science team leader) is visualized as a skill-tree. Thereafter, the processor (130) compares growth paths and required capabilities. In the embodiment, the processor (130) can calculate a growth potential score (0-100%) by comparing required capabilities of the corporate roadmap with the talent's skill-tree. In addition, the path between the current job position and target job position is expressed with nodes and edges, and the difference between required capabilities and possessed capabilities is visually emphasized (lacking skills in red, possessed skills in green) to clearly recognize the talent's growth potential. In the embodiment, the path between the current job position and target job position includes a central node, a final target node, and intermediate nodes, where the central node can represent the current job position. The final target node represents the target job position, and intermediate nodes can represent necessary skills, certifications, and experiences.

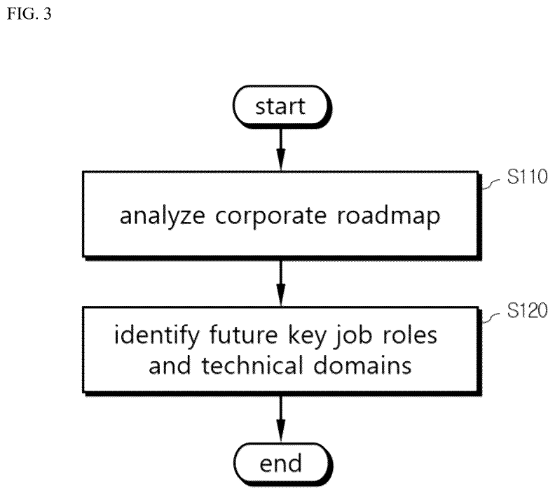

Hereinafter, FIG. 3 will be described. The method for predicting required talent based on a corporate roadmap illustrated in FIG. 3 may be performed by an apparatus for predicting required talent based on a corporate roadmap (100) including a processor (130).

Meanwhile, FIG. 3 is merely exemplary, and the spirit of the present invention is not limited to what is illustrated in FIG. 3. For example, each step may be configured in a different order from that illustrated in FIG. 3, at least one of the steps illustrated in FIG. 3 may not be performed, or one or more steps not illustrated in FIG. 3 may be additionally performed.

Hereinafter, the method for predicting required talent based on a corporate roadmap will be described in order. Since the operations (functions) of the method according to the embodiment are essentially the same as the functions of the system, descriptions overlapping with FIGS. 1 and 2 will be omitted.

FIG. 3 is a diagram illustrating a process for predicting required talent based on a corporate roadmap according to an embodiment.

Referring to FIG. 3, in step S110, corporate-provided data is structured, and the corporate roadmap is analyzed through an artificial intelligence model based on the structured corporate-provided data. In step S120, future key job roles and technical domains required according to the corporate roadmap are identified based on the analysis result.

The apparatus and method for predicting required talent based on a corporate roadmap according to an embodiment integrates and structures various internal data such as a corporate's business plan, technology roadmap, organizational expansion plan, etc., thereby predicting key job roles and technical domains needed in the future.

In addition, the apparatus and method for predicting required talent based on a corporate roadmap according to an embodiment enables objective and data-centric required talent prediction based on an AI algorithm without relying on existing empirical judgment. For example, it allows an automobile company aiming to develop autonomous vehicles to pre-hire and train autonomous driving software developers and AI engineers in line with specific milestones.

In addition, through the embodiment, emergency personnel hiring due to rapid market changes can be reduced, thereby increasing the efficiency of corporate operations.

In addition, through the embodiment, customized required talent by corporate growth stage is predicted, so that talent suitable for the stage can be predicted and prepared in advance according to different talent types required by corporate growth stage (initial, growth, maturity).

In addition, through the embodiment, in the initial stage, research and development (R&D) talent, in the growth stage, sales talent related to market expansion, and in the maturity stage, data analysis talent for operational optimization, etc., can be secured. In the case of a startup corporate, development personnel is important in the initial stage, and marketing and sales talent is important in the growth stage, so required talent by growth stage can be secured in advance through this system.

In addition, through the embodiment, required talent can be adjusted according to the corporate's growth speed, thereby preventing personnel surplus or personnel shortage phenomena.

In addition, through the embodiment, by clarifying talent requirements aligned with milestones of the corporate roadmap, roadmap-based goal-oriented talent management is enabled. Through this, required job roles and skills are clarified in line with major milestones such as specific product launch dates, project completion points, etc., thereby coordinating the type of required talent and talent securing schedule. In addition, through the embodiment, problems of project delays due to failure to secure required talent in time can be prevented. In addition, through the embodiment, a semiconductor manufacturer secures specific engineers (equipment engineers, process engineers, etc.) in advance in line with the fine process development schedule, thereby supporting pre-hiring and training of suitable talent in line with specific milestones.

In addition, since required job roles and skills also fluctuate in line with technological advancements or industry changes, through the embodiment, talent requirements can be automatically updated whenever the corporate's strategy changes or technology trends change.

In addition, talent securing strategies can be adjusted to meet new job requirements by agilely responding to technology changes.

In addition, through the embodiment, long-term talent pool management and pre-securing of future talent enable stable supply of core talent by securing required talent in advance in line with the corporate's mid- to long-term growth strategy. In addition, through the embodiment, talent needed at a specific point in time can be prepared in advance, thereby preventing emergency hiring situations and resolving talent supply-demand imbalances.

In addition, through the embodiment, skills and career changes of talent registered in the talent pool are tracked in real time, thereby proactively securing candidates suitable for specific job roles.

In addition, through the embodiment, personalized career development is supported by visualizing a talent's capability-development skill-tree.

In addition, through the embodiment, skills, certifications, experiences, etc., required for candidates and employees to reach a specific career stage (e.g., project leader, department head) are visualized, thereby presenting clear career development goals, and providing clear growth paths to talent desiring job promotion or career transition, thereby strengthening employee engagement and motivation.

In addition, through the embodiment, a virtuous cycle structure in which employees and the corporate grow together is built by connecting the corporate's mid- to long-term strategy and employees' career goals, and when employees recognize that their career growth path aligns with the company's roadmap, turnover intention decreases and engagement improves.

In addition, through the embodiment, existing employees transition to new job roles through job transition education, thereby reducing external hiring costs.

Meanwhile, the methods according to various embodiments of the present invention described above may be implemented in the form of applications or software programs that can be installed in existing electronic devices.

In addition, all or part of the method may be composed of several software function modules and implemented in an operating system (OS). Alternatively, each step may be composed of one software function module, or steps may be combined to form one software function module and implemented on an operating system. Therefore, even if not all embodiments of the present disclosure are implemented as one software function module, if several software function modules implement each step of the present disclosure and are implemented in one operating system, it can be understood as implementing the method of the present disclosure.

In addition, the methods according to various embodiments of the present invention described above may be implemented only by software upgrades or hardware upgrades for existing electronic devices. In addition, the various embodiments of the present invention described above may be performed through an embedded server provided in an electronic device or an external server of the electronic device.

Meanwhile, according to an embodiment of the present invention, the various embodiments described above may be implemented as software including instructions stored in a computer-readable recording medium that can be read by a computer or similar device using software, hardware, or a combination thereof. In some cases, the embodiments described herein may be implemented by the processor itself. In software implementation, embodiments such as procedures and functions described herein may be implemented as separate software modules. Each software module may perform one or more functions and operations described herein.

Meanwhile, a computer or similar device is a device capable of calling stored instructions from a storage medium and operating according to the called instructions, and may include a device according to the disclosed embodiments. When the instructions are executed by a processor, the processor may directly or using other components under the control of the processor perform functions corresponding to the instructions. Instructions may include code generated or executed by a compiler or interpreter.

A machine-readable recording medium may be provided in the form of a non-transitory computer readable recording medium. Here, ‘non-transitory’ merely means that the storage medium does not include a signal and is tangible, and does not distinguish whether data is stored semi-permanently or temporarily in the storage medium. At this time, a non-transitory computer-readable medium means a medium that stores data semi-permanently and can be read by a device, rather than a medium that stores data for a short moment, such as registers, caches, memory, etc. Specific examples of non-transitory computer-readable media may include CD, DVD, hard disk, Blu-ray disk, USB, memory card, ROM, etc.

As described above, exemplary embodiments have been disclosed in the drawings and specification. Although specific terms have been used herein to describe the embodiments, they have been used only for the purpose of describing the technical idea of the present disclosure and not to limit the meaning or the scope of the present disclosure described in the claims. Therefore, those skilled in the art will understand that various modifications and equivalent other embodiments are possible therefrom. Accordingly, the true technical protection scope of the present disclosure should be determined by the technical idea of the appended claims.

What is claimed is:

1. An apparatus for predicting a required talent, comprising:
a memory storing at least one instruction for predicting required talent based on a corporate roadmap; and
a processor configured to perform operations according to the instructions,
wherein the processor is configured to:
structure corporate-provided data, analyze the corporate roadmap through an artificial intelligence model based on the structured corporate-provided data, and identify future key job roles and technical domains required according to the analyzed corporate roadmap;
determine a corporate growth stage through the analyzed corporate roadmap, and predict a required talent corresponding to the future key job roles and technical domains for each company based on the determined corporate growth stage; and
specify the required talent for each corporate growth stage based on at least one milestone that serves as a target for each corporate growth stage of the corporate roadmap.

2. The apparatus of claim 1, wherein the processor is configured to:
generate a capability-development skill-tree according to individual information of each candidate, and generate a company-specific recommended talent list from among candidates whose generated capability-development skill-tree are matched with the corporate roadmap.

3. The apparatus of claim 2, wherein the processor is configured to:
extract required skills, certifications, and experience information from individual information of each candidate to achieve the capability-development skill-tree matched with the corporate roadmap.

4. The apparatus of claim 2, wherein the processor is configured to:
extract specific capabilities required in a mid- to long-term strategy according to the corporate roadmap, and select recommended talent based on whether the specific capabilities can be achieved from the capability-development skill-tree of each candidate.

5. The apparatus of claim 2, wherein the processor is configured to:
update a required talent list according to changes in corporate strategy on the corporate roadmap and changes in the candidates' career histories.

6. The apparatus of claim 1,
wherein the corporate-provided data includes at least one of a business plan, a technology roadmap, and an organizational expansion plan.

7. A method for predicting required talent based on a corporate roadmap performed by an apparatus for predicting required talent based on a corporate roadmap, the method comprising:
structuring corporate-provided data, and analyzing the corporate roadmap through an artificial intelligence model based on the structured corporate-provided data;
identifying future key job roles and technical domains required according to the analyzed corporate roadmap;
determining a corporate growth stage through the analyzed corporate roadmap, and predict a required talent corresponding to the future key job roles and technical domains for each company based on the determined corporate growth stage; and
specifying the required talent for each corporate growth stage based on at least one milestone that serves as a target for each corporate growth stage of the corporate roadmap.
